(19) United States
(12) Patent Application Publication
(10) Pub. No.: US 2012/0038764 A1
(43) Pub. Date: Feb. 16, 2012

(54) SPATIAL INFORMATION INTEGRATED DATABASE GENERATING APPARATUS AND COMPUTER READABLE MEDIUM STORING SPATIAL INFORMATION INTEGRATED DATABASE GENERATING PROGRAM

(75) Inventors: Hideaki Kurosu, Sagamihara-shi (JP); Chikakuni Maeda, Yokohama-shi (JP); Toshiaki Sato, Sagamihara-shi (JP); Akihiro Morita, Inagi-shi (JP); Katsuya Homma, Tokyo (JP)

(73) Assignee: PASCO CORPORATION, Tokyo (JP)

(21) Appl. No.: 12/857,144

(22) Filed: Aug. 16, 2010

(51) Int. Cl. H04N 7/18; G06K 9/00

(52) U.S. Cl. 348/116; 382/103; 348/E07.085

(57) ABSTRACT

An image receiving unit receives an image captured by a capturing device at a capturing interval of the predetermined distance. A movement direction acquiring unit acquires a movement direction of the vehicle based on calibration information acquired in advance and the image information. A database generating unit determines whether capturing position information of the image information and setting points of spatial codes are matched with each other. When they are matched with each other, the database generating unit associates the image information and the spatial codes with each other. When they are not matched with each other, a capturing position allocating unit executes a process of allocating the image information between the setting points of the spatial codes, and the database generating unit associates the allocated image information with a position between the spatial codes.

### BACKGROUND OF THE INVENTION

1. Field of the Invention

The present invention relates to a spatial information integrated database generating apparatus and computer readable medium storing spatial information integrated database generating program.

2. Description of the Related Art

Conventionally, images of points on a road are captured and road management or traffic control of an automobile is performed using the images. In this case, a camera is mounted in a vehicle, such as the automobile, and images of the road and surrounding images of the road are captured by the camera provided in the vehicle. The composition where captured position information acquired by a global positioning system (GPS) is associated with the captured images and a corresponding image is reproduced when a desired position on a map is designated is known.

For example, Japanese Patent Application Laid-Open (JP-A) No. 2002-258740 discloses an image recording apparatus and an image recording method that enable captured image data and positions of real spaces to be associated with each other through a simple operation. Japanese Patent Application Laid-Open (JP-A) No. 2001-290820 discloses a video collecting device, a video searching device, and a video collecting/searching system that can associate video data obtained by capturing various spaces and position/time data with each other on the basis of a time, search and reproduce and edit the video data by making the video data correspond to capturing positions.

However, according to a technology disclosed in JP-A No. 2002-258740, since an operator associates the captured image data with the positions of the real spaces while viewing the captured image data, the operator needs to perform complicated work for searching and confirming the captured image data. According to a technology disclosed in JP-A No. 2001-290820, since the image captured position of the video data is acquired using the GPS, only outdoor images are target. For this reason, indoor images cannot be target and the indoor images and the positions on the map cannot be associated with each other.

### SUMMARY OF THE INVENTION

According to a first aspect of the invention, there is provided a spatial information integrated database generating apparatus, including: a capturing unit that is mounted in a vehicle and captures surrounding portions of the vehicle at a capturing interval of the predetermined distance; a movement direction acquiring unit that acquires a movement direction of the vehicle based on calibration information acquired in advance and image information obtained by the capturing unit; and a database generating unit that generates a spatial information integrated database where the image information and captured target position information are associated based on the movement direction of the vehicle and the capturing interval.

According to a second aspect of the invention, there is provided the spatial information integrated database generating apparatus according to the first aspect, wherein the captured target position information is configured by spatial codes uniquely set to identify places with social significances and graph data indicating a connection relationship between the spatial codes.

According to a third aspect of the invention, there is provided the spatial information integrated database generating apparatus according to the second aspect, further including: a capturing position allocating unit that allocates image information between setting points of the spatial codes based on the setting points of the spatial codes and the capturing interval.

According to a fourth aspect of the invention, there is provided the spatial information integrated database generating apparatus according to any one of the first to third aspect, wherein the calibration information is determined based on a relationship between a positional change of the vehicle in a target space where a predetermined target is provided and a positional change of the target in an image captured by the capturing unit.

According to a fifth aspect of the invention, there is provided the spatial information integrated database generating apparatus according to the first to fourth aspect, wherein, when the vehicle moves on a curved line, the number of images captured by the capturing unit is larger than that of when the vehicle moves on a straight line.

According to a sixth aspect of the invention, there is provided the spatial information integrated database generating apparatus according to any one of the first to fifth aspect, wherein the vehicle is an electrically powered vehicle.

According to a seventh aspect of the invention, there is provided a computer readable medium storing a spatial information integrated database generating program causing a computer to function as: an image receiving unit that receives image information obtained by capturing surrounding portions of a vehicle at a capturing interval of the predetermined distance by a capturing unit mounted in the vehicle; a movement direction acquiring unit that acquires a movement direction of the vehicle based on calibration information acquired in advance and the image information received by the image receiving unit; and a database generating unit that generates a spatial information integrated database where the image information and captured target position information are associated based on the movement direction of the vehicle and the capturing interval.

### BRIEF DESCRIPTION OF THE DRAWINGS

Exemplary embodiments of the present invention will be described in detail based on the following figures, wherein:

FIG. 1 is a diagram illustrating an example of the hardware configuration of a spatial information integrated database generating apparatus according to an embodiment;

FIG. 2 is a diagram illustrating an example of a vehicle that mounts a capturing device;

FIG. 3 is a diagram illustrating an example of the hardware configuration of a computer that constitutes an information processing device illustrated in FIG. 1;

FIG. 4 is a functional block diagram illustrating a spatial information integrated database generating apparatus according to an embodiment;

FIG. 5 is an explanatory diagram illustrating a process of acquiring calibration information used by a movement direction acquiring unit;

FIGS. 6A to 6C are explanatory diagrams illustrating a process of acquiring a movement direction of a vehicle by the movement direction acquiring unit;

FIGS. 7A to 7D are explanatory diagrams illustrating a process of acquiring the movement direction of the vehicle by the movement direction acquiring unit;

FIG. 8 is an explanatory diagram illustrating a process of associating image information and captured target position information on a position of a target from which the image information is obtained, to cause a database generating unit to generate a spatial information integrated database; and

FIG. 9 is a flowchart illustrating an example of the operation of the spatial information integrated database generating apparatus according to the embodiment.

### DETAILED DESCRIPTION OF THE EXEMPLARY EMBODIMENTS

An exemplary embodiments of the present invention (referred to as “an embodiment” below) will be described hereinafter.

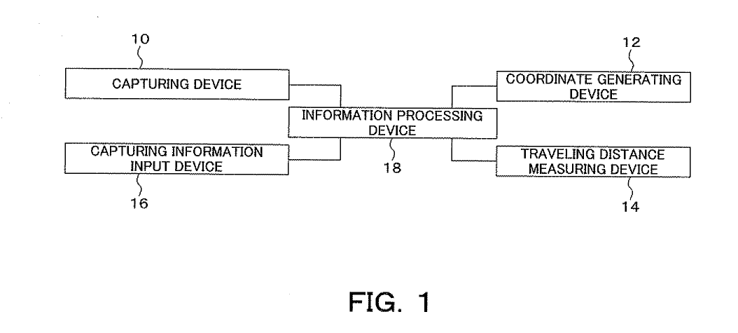

FIG. 1 illustrates an example of the hardware configuration of a spatial information integrated database generating apparatus according to an embodiment. In FIG. 1, the spatial information integrated database generating apparatus includes a capturing device 10, a coordinate generating device 12, a traveling distance measuring device 14, a capturing information input device 16, and an information processing device 18.

The capturing device 10 is a device that is appropriately mounted in a vehicle and captures surrounding images of the vehicle at a capturing interval of the predetermined distance, and is composed of a digital camera or a video camera. The capturing device 10 is configured to enable capturing of the front side of a movement direction of the vehicle, the rear side thereof, both sides thereof or all directions thereof. In order to capture the front side or the rear side of the movement direction of the vehicle, for example, a method that disposes a camera on the front side or the rear side of the vehicle is known. In order to capture both sides of the vehicle, for example, a method that disposes cameras on both sides of the vehicle is known. In order to capture all directions of the vehicle, a method using an omnidirectional camera is known. The predetermined distance used as the capturing interval is measured by the traveling distance measuring device 14 to be described below.

The coordinate generating device 12 is composed of a GPS receiver and generates geographical coordinates of the capturing position where the capturing device 10 takes an image. Since the spatial information integrated database generating apparatus according to the embodiment uses spatial codes (which are described below) as the captured target position information to handle an image captured indoors, the coordinate generating device 12 composed of the GPS receiver is not an essential element and may be omitted.

The traveling distance measuring device 14 is composed of an appropriate distance meter and measures the traveling distance of the vehicle that mounts the capturing device 10. The format of the distance meter is not particularly limited. For example, a non-contact-type distance meter based on a spatial filter method or a distance meter that measures the traveling distance from the number of revolutions of wheels can be used.

The capturing information input device 16 includes a key and a switch such as an appropriate push button, and a driver of the vehicle inputs capturing information through the switch and the key before or during the traveling of the vehicle. The capturing information can include a position where the spatial code to be described below is set, a point where a traveling path is curved, a capturing interval (capturing pitch) of the capturing device 10, a distinction between indoor and outdoor spaces of a image captured place, weather at the time of capturing, and information about an operator of the capturing device 10 etc. The capturing information is transmitted to the information processing device 18 to be described below.

The information processing device 18 is composed of a computer and executes various processes needed to generate a spatial information integrated database. The process contents will be described in detail below.

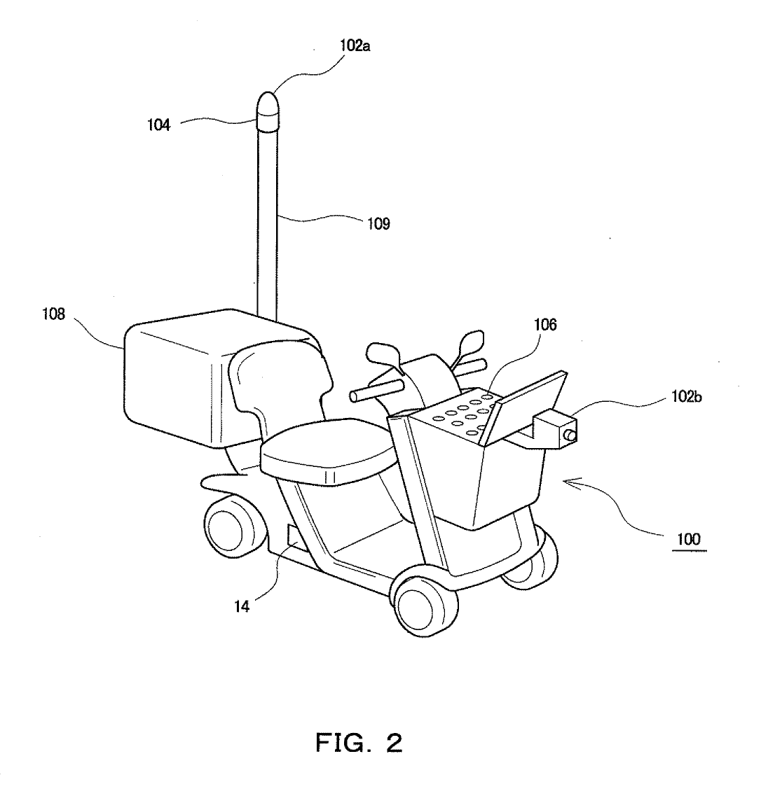

FIG. 2 illustrates an example of a vehicle that mounts the capturing device 10. In FIG. 2, a vehicle 100 is composed of an electrically powered vehicle and is mounted with cameras 102a and 102b functioning as the capturing device 10, a GPS receiver 104, an operation panel 106 functioning as the capturing information input device 16, and a storage box 108 storing the information processing device 18. The camera 102a and the GPS receiver 104 may be disposed on a support 109. In this embodiment, the camera 102a is an omnidirectional camera and the camera 102b is a camera that captures the front side, but the present invention is not limited thereto. Also, the number of cameras is not limited to two and may be one or three or more. In this embodiment, the traveling distance measuring device 14 is provided in the vicinity of a rear wheel, but the present invention is not limited thereto.

Since the vehicle 100 according to this embodiment is composed of the electrically powered vehicle, the vehicle 100 can travel indoors as well as outdoors, different from a vehicle driven by a gasoline engine. For this reason, indoor and outdoor images can be captured.

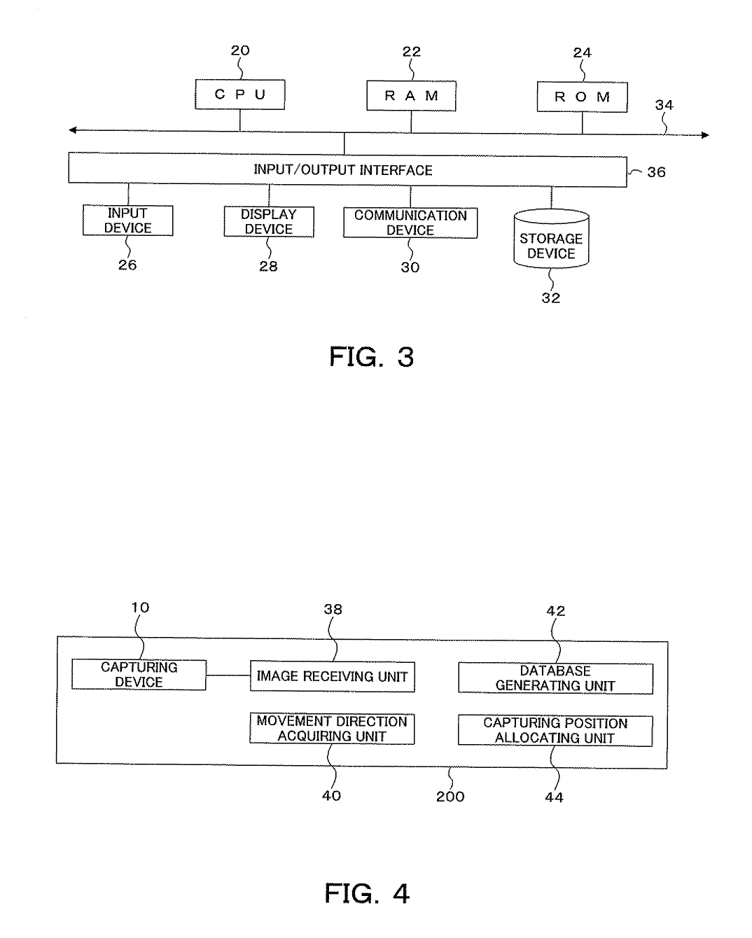

FIG. 3 illustrates an example of the hardware configuration of a computer that constitutes the information processing device 18 illustrated in FIG. 1. In FIG. 3, the information processing device 18 includes a central processing unit (for example, a CPU, such as a microprocessor, can be used) 20, a random access memory (RAM) 22, a read only memory (ROM) 24, an input device 26, a display device 28, a communication device 30, and a storage device 32, and these components are connected to each other by a bus 34. The input device 26, the display device 28, the communication device 30, and the storage device 32 are connected to the bus 34 through an input/output interface 36, respectively.

The CPU 20 controls the operation of the various units to be described below based on a control program stored in the RAM 22 or the ROM 24. The RAM 22 mainly functions as a work area of the CPU 20 and the ROM 24 stores a control program, such as BIOS, and the other data used by the CPU 20.

The input device 26 is composed of a keyboard or a pointing device and is used when a user inputs an operation instruction.

The display device 28 is composed of, for example, a liquid crystal display and displays map information and information of an image captured by the capturing device 10.

The communication device 30 is composed of a universal serial bus (USB) port, a network port or the other appropriate interface and is used when the CPU 20 exchanges data with an external device through a communication unit, such as a network.

The storage device 32 is a magnetic storage device, such as a hard disk, and stores a variety of data needed to execute processes to be described below. As the storage device 32, a digital versatile disc (DVD), a compact disk (CD), a magneto-optical disk (MO), a flexible disk (FD), a magnetic tape, an electrically erasable and programmable read only memory (EEPROM) or a flash memory or the like may be used, instead of the hard disk.

The information processing device 18 does not need to be mounted in the vehicle 100, and may be configured to acquire needed information from the capturing device 10, the coordinate generating device 12, the traveling distance measuring device 14, and the capturing information input device 16 through the storage device 32 or the communication device 30.

FIG. 4 is a functional block diagram illustrating a spatial information integrated database generating apparatus according to an embodiment. In FIG. 4, a spatial information integrated database generating apparatus 200 includes a capturing device 10, an image receiving unit 38, a movement direction acquiring unit 40, a database generating unit 42, and a capturing position allocating unit 44, and functions of these components are realized by a program controlling the CPU 20 and a processing operation of the CPU 20, except for the capturing device 10.

The image receiving unit 38 receives surrounding images of the vehicle 100, which are captured by the capturing device 10 for each capturing interval of the predetermined distance, as image information. The position where the capturing device 10 is capturing is determined by the capturing interval. For example, the position can be represented as the distance from an appropriate reference point. The distance from the reference point is set as the capturing position information, and the distance and the received image information are stored in the storage device 32 and transmitted to the database generating unit 42. The reference point can be set as an arrangement point of the spatial code to be described below.

The movement direction acquiring unit 40 acquires a movement direction of the vehicle 100 based on the calibration information acquired in advance and the information of the image captured by the capturing device 10. The acquiring process of the calibration information and the movement direction is described in detail below. Information of the acquired movement direction is stored in the storage device 32 and transmitted to the database generating unit 42.

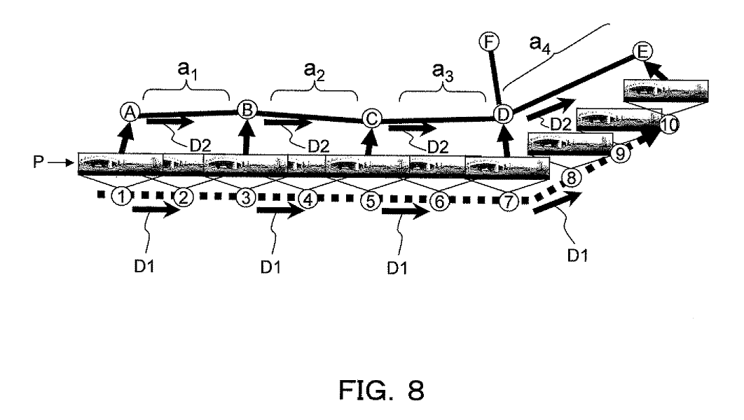

The database generating unit 42 generates a spatial information integrated database where image information and captured target position information on a captured target position of the image information are associated with each other and stores the spatial information integrated database in the storage device 32. The captured target position information can be configured by spatial codes uniquely set to identify places with social significances and graph data indicating a connection relationship between the spatial codes. In this case, the spatial codes can be set for each building, each floor or each block of an office building or a commercial facility, each division of a factory or a warehouse, and each unit of a room or a shelf. The connection relationship indicated by the graph data includes identification information (ID etc.) of the adjacent spatial codes and information of the distances with the adjacent spatial codes, or the like. The spatial codes and the graph data are previously associated with each other and information of the spatial codes and the graph data is stored in the storage device 32. At the point where the spatial code is set, a driver of the vehicle 100 inputs capturing information indicating that the corresponding point is a spatial code setting point, through the capturing information input device 16. Alternatively, the capturing information input device 16 may be configured to have an appropriate communication function, a transmitter that transmits a signal indicating the spatial code may be provided in the setting point of the spatial code, and the capturing information input device 16 may communicate with the transmitter and recognize the setting point of the spatial code. In the communication, a short range radio communication technique, such as an IC tag (RFID (Radio Frequency IDentification), may be used. Thereby, the distance by which the vehicle 100 travels from the reference point and the spatial code can be associated with each other. The spatial code that is input from the capturing information input device 16 or is recognized and the graph data associated with the spatial code in advance are stored in the storage device 32 as the capturing information. The database generating unit 42 reads the capturing information and the image information from the storage device 32 and associates the image information and the spatial code based on the distance information from the reference point corresponding to the capturing position information included in the image information. When there is no image information captured at the position matched with the spatial code setting point, the database generating unit 42 may select image information captured at the capturing position closest to the spatial code setting point or identification information of the image information based on the image captured position information, and associate the selected image information and the spatial code with each other. When the image information and the spatial code are associated with each other, the movement direction of the vehicle 100 is also used, which will be described below with reference to FIG. 8. The spatial code may be associated with the map information. In this case, since the outdoor image information is target, the map information and the spatial code may be associated using the geographical coordinates of the capturing position generated by the coordinate generating device 12. Thereby, the capturing position of the image may be grasped on the map.

The capturing position allocating unit 44 allocates the image information between the spatial code setting points based on the spatial code setting points and the capturing interval. That is, the database generating unit 42 grasps the spatial code setting point based on the capturing information input from the capturing information input device 16 as described above. However, image information captured between the two points where the spatial codes are set needs to be allocated to the position between the spatial codes. For this reason, the capturing position allocating unit 44 allocates the image information, which is captured between the spatial code setting points, between the spatial code setting points.

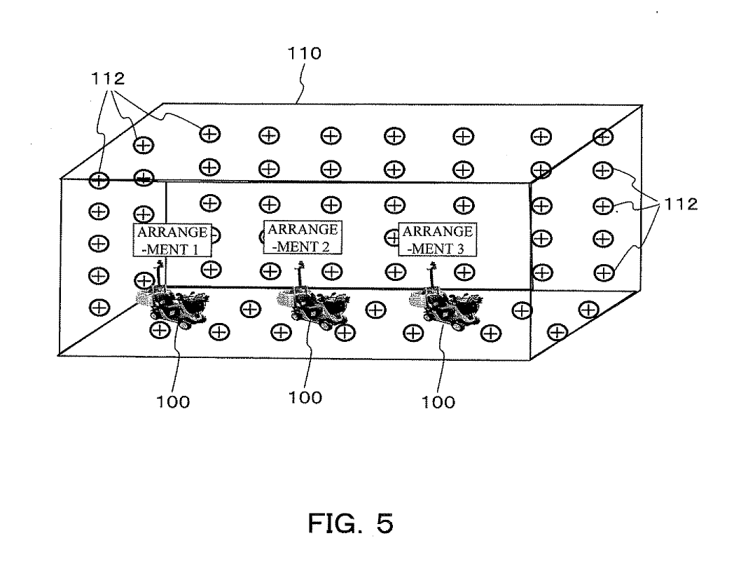

FIG. 5 illustrates a process of acquiring calibration information used by the movement direction acquiring unit 40. In FIG. 5, the vehicle 100 is disposed in a target space 110, and plural targets 112 whose positions are measured in advance are disposed in the target space 110. The positions of the targets 112 are measured by a position measuring device, such as a total station.

When the calibration information is acquired, all or part of the targets 112 is captured by the camera 102a while the arrangement position of the vehicle 100 disposed in the target space 110 is changed. In FIG. 5, after the target 112 is captured at the arrangement position 1 (displayed as arrangement 1) of the vehicle 100, the vehicle 100 is sequentially moved to the arrangement position 2 (arrangement 2) and the arrangement position 3 (arrangement 3) and the target 112 is captured at the individual arrangement positions. Thereby, a change direction and the change amount (such as the movement distance and a rotation angle) of the position of the target 112 of the image captured by the camera 102a and the predetermined distance apart from the camera can be calculated according to the movement direction and the movement distance of the vehicle 100. The change direction and the change amount of the position of the target 112 of the image that is the predetermined distance apart from the camera are the calibration information.

In the example of FIG. 5, the vehicle 100 is linearly moved, but a movement method of the vehicle 100 is not limited thereto. For example, the vehicle 100 is moved on a curved line of various curvatures or is moved, even though, on a straight line with various direction, and the calibration information is acquired in consideration of many traveling circumferences of the vehicle 100, such as various capturing direction of the camera 102a, at the time of capturing.

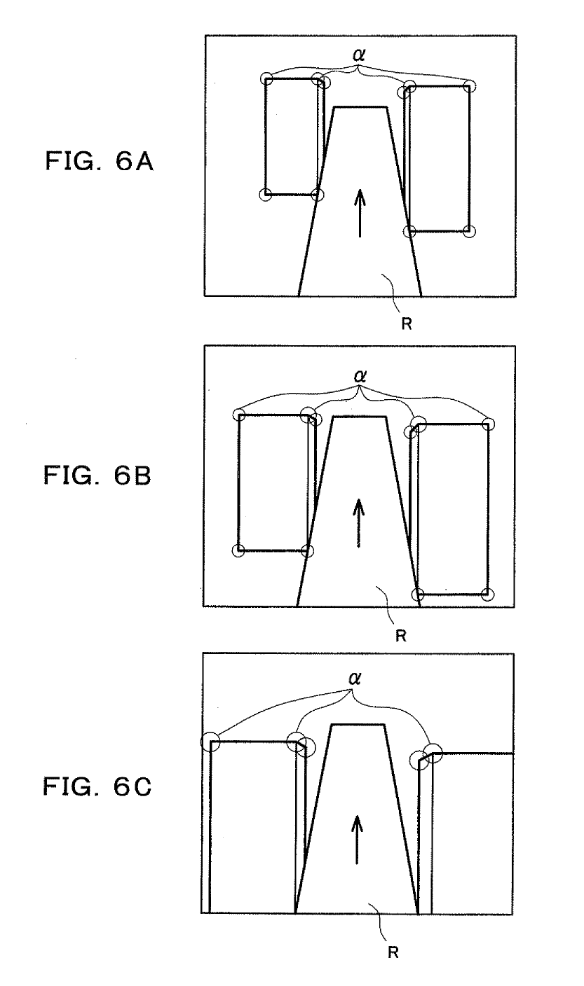

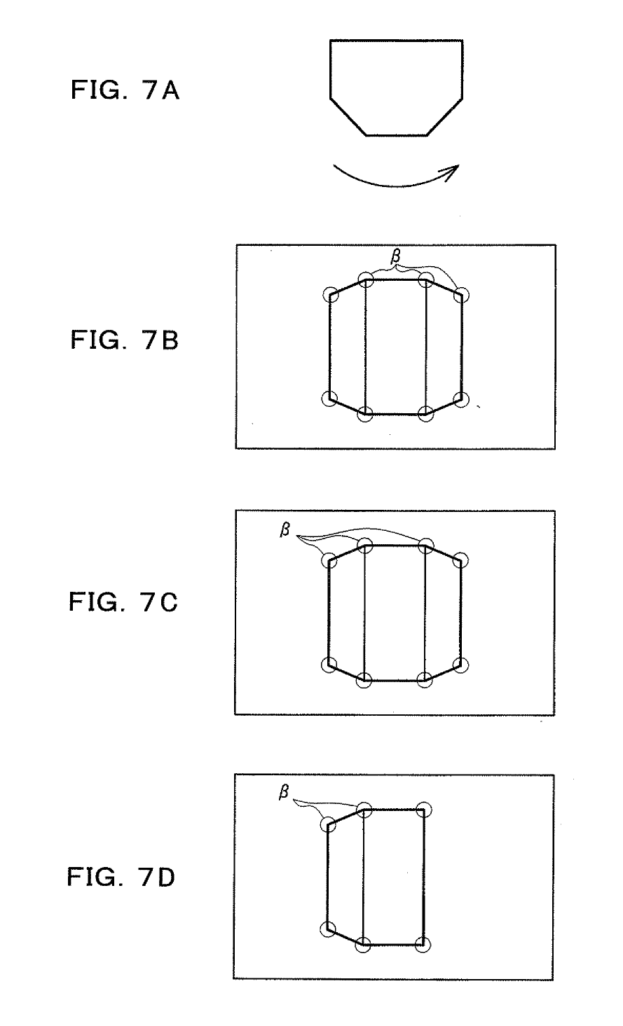

FIGS. 6A to 6C and FIGS. 7A to 7D illustrate a process of acquiring the movement direction of the vehicle 100 by the movement direction acquiring unit 40.

FIGS. 6A to 6C illustrate an example of the case where the vehicle 100 goes straight. In FIGS. 6A to 6C, surrounding images of the vehicle 100 are captured while the vehicle 100 goes straight on a traveling path R in an arrow direction. In this example, an image captured by the camera 102b capturing the front side illustrated in FIG. 2 is exemplified, but the image may be captured by the omnidirectional camera 102a. When the process of acquiring the movement direction is executed, an appropriate point in the image is determined as a feature point and the change direction and the change amount of the position of the feature point in the image according to the movement of the position of the vehicle 100 are acquired. In the example of FIGS. 6A to 6C, a feature point α is set to a corner of the building and is illustrated by a circle (O). When the vehicle 100 travels and the position thereof moves, the position of the feature point α in the image moves to the near side of the image in the order of FIGS. 6A, 6B, and 6C. The movement direction acquiring unit 40 images the same feature point a before and after the movement and calculates the distance from the camera 102b to the feature point α using a method, such as triangulation. The movement direction acquiring unit 40 calculates the movement direction of the vehicle 100, based on the distance, the movement direction and the movement distance of the feature point α and the previously acquired calibration information.

FIGS. 7A to 7D illustrate an example of the case where the vehicle 100 travels on the curved line (curved traveling). FIG. 7A illustrates a horizontal cross-sectional view of a building that is a captured target. The camera 102b of the vehicle 100 sequentially captures the building while the vehicle goes around the building in a counterclockwise direction as illustrated by an arrow. Even in this embodiment, a feature point β is set in the image and is illustrated by a circle (O) in FIGS. 7B to 7D. When the camera 102b of the vehicle 100 captures the building while going around the building, the position of the feature point β revolves and moves in the image in the order of FIGS. 7B, 7C, and 7D. As illustrated in FIG. 7D, the feature point β is hidden behind the building and disappears. As such, as the vehicle 100 travels in a curved line, the feature point β in the image captured from the vehicle 100 also revolves and moves. Therefore, the movement direction acquiring unit 40 images the same feature point β before and after the movement, and calculates the distance from the camera 102b to the feature point β using a method, such as triangulation. The movement direction acquiring unit 40 calculates the movement direction of the vehicle 100, based on the distance, the movement direction and the movement distance of the feature point β, and the previously acquired calibration information. When the vehicle moves on the curved line, the feature point β disappears fast as compared with when the vehicle moves on the straight line. For this reason, when the vehicle moves on the curved line, the capturing interval is shorter than that of when the vehicle moves on the straight line, the number of images captured by the capturing device 10 increases, and the data amount increases. If the number of cameras is set to three or more or the omnidirectional camera 102a is used, instead of the camera 102b, the capturing omission of the feature point β can be prevented.

FIG. 8 illustrates a process of associating image information and captured target position information on a position of a target from which the image information is obtained, to cause the database generating unit 42 to generate a spatial information integrated database. In FIG. 8, A to E illustrate setting points of spatial codes used as captured target position information, and a solid line that connects the setting points of the spatial codes illustrates a traveling route of the vehicle 100. The spatial codes are set on the traveling route. The traveling route is included in contents of the graph data indicating the connection relationship between the spatial codes. In FIG. 8, a traveling trace of the vehicle 100 is illustrated by a broken line. The database generating unit 42 determines the traveling trace based on the movement direction and the traveling distance of the vehicle 100 acquired by the movement direction acquiring unit 40. Numerical values 1 to 10 surrounded by circles illustrate capturing position information where surrounding images are captured from the vehicle 100. For example, the capturing position information can be represented as the distances from the spatial code A. The distances a1, a2, a3, and a4 between the spatial codes A to E are defined in the graph data. FIG. 8 illustrates the case where images P captured at each capturing position are associated with image captured position information.

The database generating unit 42 reads the capturing information and the image information from the storage device 32 and executes a process of associating the image information and the spatial codes included in the capturing information. In this embodiment, the database generating unit 42 associates each of the spatial codes A to E with the image information. In this case, as described above, the database generating unit 42 compares the position information (captured target position information) of the arrangement points of the spatial codes A to E and the capturing position information of the image information and associates the matched spatial codes and image information with each other. The user may previously inputs the spatial codes corresponding to starting and end points (both endpoints) of a section where the image information is associated, through the input device 26, and designates the spatial codes. Thereby, the database generating unit 42 can previously acquire information on a section where the associating process is executed. As illustrated in FIG. 8, bifurcation may exist in the association relationship included in the graph data on the spatial code D and the two spatial codes E and F may exist as the spatial codes connected to the spatial code D. In this case, the database generating unit 42 confirms the movement direction of the vehicle 100 that is acquired by the movement direction acquiring unit 40, and determines whether the movement direction of the vehicle 100 is a direction oriented from the spatial code D to any one of the spatial code E and the spatial code F, from the connection relationship included in the graph data on the spatial code D. In FIG. 8, the movement direction of the vehicle 100 is illustrated by an arrow D1 and the direction oriented to the adjacent spatial codes between the spatial codes is illustrated by an arrow D2. In the vicinity of the spatial code D, when the arrows D1 and D2 are compared, since the movement direction of the vehicle 100 is matched with the direction oriented from the spatial code D to the spatial code E, association of the image information with the spatial code F can be excluded. As such, the database generating unit 42 can associate the image information and the spatial code based on the movement direction of the vehicle 100. In FIG. 8, the image information at the capturing position 1 is associated with the spatial code A, the image information at the capturing position 3 is associated with the spatial code B, the image information at the capturing position 5 is associated with the spatial code C, the image information at the capturing position 7 is associated with the spatial code D, and the image information at the capturing position 10 is associated with the spatial code E. The spatial code and the corresponding graph data are associated with the image information and the spatial information integrated database according to this embodiment is configured.

The image information may be captured between the setting points of the individual spatial codes, and the image information needs to be associated with the position information between the setting points of the spatial codes. For this reason, the capturing position allocating unit 44 reads the capturing information and the image information from the storage device 32, compares the capturing position information included in the image information and the position information (captured target position information) of the setting points of the individual spatial codes included in the capturing information, and extracts image information where the capturing position information is positioned between the individual spatial codes. The capturing position allocating unit 44 generates allocation information instructing the database generating unit 42 between which the spatial codes to allocate the extracted image information and transmits the generated allocation information and the extracted image information to the database generating unit 42. Based on the allocation information, the database generating unit 42 associates the image information with the position between the corresponding spatial codes, includes the association information in the contents of the spatial information integrated database, and stores the association information in the storage device 32.

In FIG. 8, the traveling trace (broken line) of the vehicle 100 forms the straight line. In actuality, the traveling trace of the vehicle 100 may meander due to a driving skill of the user or a traveling environment, and the captured target position information previously defined by the spatial code and the capturing position information calculated from the image captured by the camera 102b may not be accurately associated with each other. In this case, total three image information or capturing information captured before and after the image information considered having the capturing position information associated with the captured target position information may be compared and the captured image considered as the captured image of which the spatial code is closest to the vehicle 100 (where the spatial code setting point is captured to have a largest size in the image information or the electric wave strength from the spatial code setting point included in the capturing information is the strongest or the like) and the capturing position information thereof may be associated with the corresponding spatial code. At this time, the capturing position information can be corrected based on the captured target position information and the influence from the meandering can be alleviated.

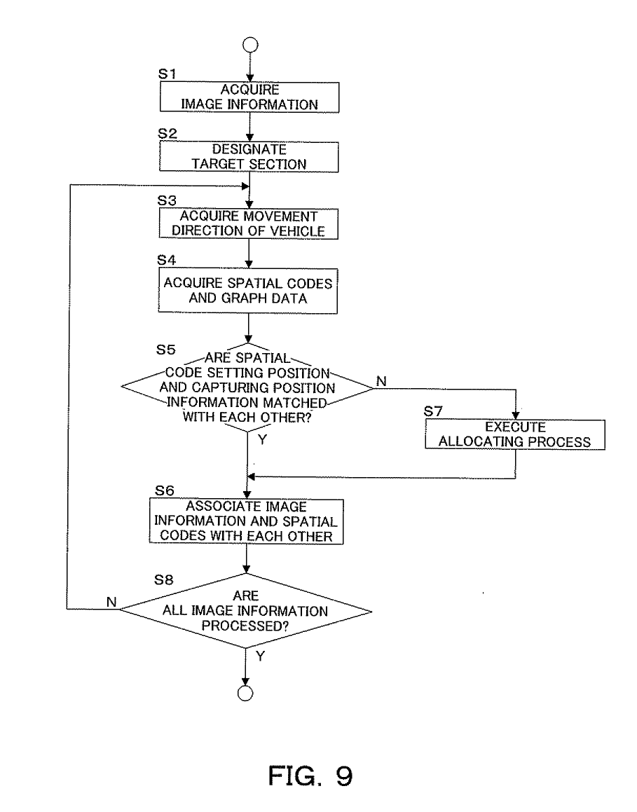

FIG. 9 is a flowchart illustrating an example of the operation of the spatial information integrated database generating apparatus according to the embodiment. In FIG. 9, information of an image captured by the capturing device 10 at each capturing interval of the predetermined distance is received by the image receiving unit 38 (S1). The user designates a target section where a process of associating the image information and the captured target position information is executed, through the input device 26 (S2).

Next, the movement direction acquiring unit 40 acquires the movement direction of the vehicle 100 (S3). The database generating unit 42 acquires the spatial code and the graph data that correspond to the captured target position information designated in the target section designated in S2 (S4).

The database generating unit 42 determines whether the capturing position information determined by the capturing interval of the image information received by the image receiving unit 38 and the setting point of the spatial code are matched with each other (S5). When it is determined in S5 that the capturing position information and the setting point of the spatial code are matched with each other, the database generating unit 42 associates the image information and the spatial code with each other (S6). Since the capturing position information is the distance from the spatial code A corresponding to a starting point of the target section designated in S2 in the example illustrated in FIG. 8, the database generating unit 42 can perform the determination of S5 through whether the distance is matched with the distance between the spatial code A and another spatial code. Alternatively, for example, the database generating unit 42 may perform the determination of S5 through whether the temporal difference of capturing timing of the image information and timing where information indicating the setting point of the spatial code is input from the capturing information input device 16 is smaller than a predetermined threshold value.

Meanwhile, when it is determined in S5 that the capturing position information and the setting point of the spatial code are not matched with each other, the capturing position allocating unit 44 executes a process of allocating the image information between the setting points of the spatial codes (S7). The database generating unit 42 associates the allocated image information with the position between the corresponding spatial codes (S6).

Next, the database generating unit 42 determines whether the process of all image information in the target section is completed (S8), and stops the process when the process of all image information is completed. When the process of all the image information is not completed, the database generating unit 42 repeats the process starting from S3.

A program that causes each step of FIG. 9 to be executed may be stored in a recording medium or may be provided through a communication unit. In this case, the program may be recognized as the invention of a “computer readable recording medium recording a program” or the invention of a “data signal”.

Although the exemplary embodiments of the invention have been described above, many changes and modifications will become apparent to those skilled in the art in view of the foregoing description which is intended to be illustrative and not limiting of the invention defined in the appended claims.

What is claimed is:

1. A spatial information integrated database generating apparatus, comprising:
a capturing unit that is mounted in a vehicle and captures surrounding portions of the vehicle at a capturing interval of the predetermined distance;
a movement direction acquiring unit that acquires a movement direction of the vehicle based on calibration information acquired in advance and image information obtained by the capturing unit; and
a database generating unit that generates a spatial information integrated database where the image information and captured target position information are associated based on the movement direction of the vehicle and the capturing interval.

2. The spatial information integrated database generating apparatus according to claim 1,
wherein the captured target position information is configured by spatial codes uniquely set to identify places with social significances and graph data indicating a connection relationship between the spatial codes.

3. The spatial information integrated database generating apparatus according to claim 2, further comprising:
a capturing position allocating unit that allocates image information between setting points of the spatial codes based on the setting points of the spatial codes and the capturing interval.

4. The spatial information integrated database generating apparatus according to claim 1,
wherein the calibration information is determined based on a relationship between a positional change of the vehicle in a target space where a predetermined target is provided and a positional change of the target in an image captured by the capturing unit.

5. The spatial information integrated database generating apparatus according to claim 1,
wherein, when the vehicle moves on a curved line, the number of images captured by the capturing unit is larger than that of when the vehicle moves on a straight line.

6. The spatial information integrated database generating apparatus according to claim 1,
wherein the vehicle is an electrically powered vehicle.

7. A computer readable medium storing a spatial information integrated database generating program causing a computer to function as:
an image receiving unit that receives image information obtained by capturing surrounding portions of a vehicle at a capturing interval of the predetermined distance by a capturing unit mounted in the vehicle;
a movement direction acquiring unit that acquires a movement direction of the vehicle based on calibration information acquired in advance and the image information received by the image receiving unit; and
a database generating unit that generates a spatial information integrated database where the image information and captured target position information are associated based on the movement direction of the vehicle and the capturing interval.
